(19) United States
(12) Patent Application Publication
(10) Pub. No.: US 2016/0306256 A1
(43) Pub. Date: Oct. 20, 2016

(54) METHOD FOR CONFIGURING AN OPTICAL MODULATOR

(71) Applicant: Chen-Kuo Sun, Escondido, CA (US)

(72) Inventors: Chen-Kuo Sun, Escondido, CA (US); Dingbo Chen, San Diego, CA (US)

(21) Appl. No.: 14/848,707

(22) Filed: Sep. 9, 2015

Related U.S. Application Data
(63) Continuation-in-part of application No. 14/687,726, filed on Apr. 15, 2015.

(51) Int. Cl. G02F 1/313; G02B 6/138; G02B 6/136

(52) U.S. Cl. CPC G02F 1/3133; G02B 6/136; G02B 6/138

(57) ABSTRACT

A method for manufacturing an electro-optically coupled switch in accordance with the present invention requires a sequential reconfiguration of a layer of semiconductor material. To begin, a base member is created wherein the semiconductor layer is positioned on a layer of insulator material with the insulator material positioned between the semiconductor layer and a semiconductor substrate. In sequence, with a first etch, the semiconductor layer is etched to create waveguides on opposite sides of a slot. In a second etch, the slot is deepened to expose the layer of insulator material in the slot. With a third contact pad doping process, pads can be positioned on top of the layer of insulator material for electrical contact with the respective waveguides. Metal contacts can then be placed on the contact pads, the slot can be filled with an electro-optical polymer and, if needed, the polymer can be poled.

This application is a continuation-in-part of application Ser. No. 14/687,726, filed Apr. 15, 2015, which is currently pending. The contents of application Ser. No. 14/687,726 are incorporated herein by reference.

### FIELD OF THE INVENTION

The present invention pertains generally to systems and methods that employ switches and modulators during the transmission of optical signals through optical waveguides. More specifically, the present invention pertains to optical switches and modulators that employ a cross-coupling material which is sandwiched between two waveguides, wherein the waveguides are aligned parallel to each other, and an electric field, E, is used to change the refractive index, n_{c}, of the cross-coupling material to transfer an optical signal from one waveguide to the other. The present invention is particularly, but not exclusively, useful as an electro-optically coupled switch wherein the cross-coupling material is structured as a thin, flat layer, and the electrical field, E, is strong and uniform, with flux lines oriented substantially perpendicular to the entire layer of cross-coupling material and confined between the waveguides.

### BACKGROUND OF THE INVENTION

It is well known that an optical waveguide is a physical structure which guides electromagnetic waves (e.g. light) through the structure. The guidance, or confinement, of light by the waveguide is the result of internal reflections within the waveguide. As a physical event, these internal reflections result when the difference between the refractive index, n_{wg}, of the waveguide material, and that of the surrounding environment, nₑ, has a certain value. Otherwise, there may be no confinement, or inefficient confinement, of light within the waveguide.

It is also well known that an applied electric field can change the refractive index of a material through a linear or nonlinear electro-optic effect such as the well-known Pockels' effect (linear) or the Kerr effect (nonlinear). In particular, the Pockels' electro-optic effect is a case wherein the influence of a voltage that is applied across a material will change the index of refraction, n, of the material by an amount, Δn, which can be mathematically expressed as:

Δn=−rn³E/2

where r is the Pockels' constant, and E is the strength of the electric field.

In the context of a planar, waveguide coupler switch, an electric field E is applied between two cross-coupled optical waveguides which are separated by an electro-optic material having a refractive index, nₑₒ. When applied, the electric field, E, changes the refractive index, nₑₒ, of the cross-coupling material to modify the cross-coupling characteristics between the two optical waveguides. As a result, light traveling along one waveguide is moved to the other waveguide.

With the above in mind, the design of a vertical, waveguide optical switch as envisioned for the present invention involves several interactive factors of particular importance. These include: the separation distance, d, between the waveguides (i.e. the thickness of the cross-coupling material); the refractive index of the cross-coupling material, n_{c}, (also sometimes referred to herein as nₑₒ); and the design (i.e. configuration) of the electric field E.

In particular, insofar as the design of the electric field is concerned, the ability of the device (i.e. electro-optic switch) to configure and confine the electric field, E, relative to the cross-coupling material is of paramount importance. Specifically, the concern here for a design of the electric field, E, is three-fold. First: the electric field, E, passing through the cross-coupling material should be uniform (i.e. the electric field flux lines are parallel to each other). Second: flux lines of the electric field, E, should be confined to the cross-coupling material. And third: the flux lines of the electric field, E, should be aligned with the polarization direction of the cross-coupling material (i.e. perpendicular to the light beam pathway in the waveguides). The purpose for harmonizing these factors is to optimize the electro-optic modulation efficiency of the device.

In another aspect of the present invention, the structure of an electro-optically coupled switch (modulator) is considered for the purpose of operationally accommodating an optical signal. The object here is to optimize the orientation of the optical signal's electric field for transit of the optical signal through the cross-coupling material between waveguides. This requires that the orientation established by the electro-optic coefficient of the cross-coupling material be substantially parallel (i.e. in the same direction), or nearly so, to the optical signal's electric field.

It is known that a laser beam (i.e. optical signal) will have both an electric field and a magnetic field that are oriented in mutually orthogonal planes. A consequence of this is that a waveguide will impose conditions on the optical signal which will cause it to exhibit transverse modes. In particular, these modes are either a TM (Transverse Magnetic) mode wherein the electric field is vertical and the magnetic field is horizontal; or a TE (Transverse Electric) mode wherein the electric field is horizontal and the magnetic field is vertical. It is also known that an electro-optic cross-coupling material, positioned between two waveguides, will exhibit a unique polarizing plane that is most responsive to the electric field of an optical signal passing through the cross-coupling material.

Thus, the orientation of a response plane in a cross-coupling material is important insofar as an alignment of this response plane with the flux lines of an externally applied electric field, E, is concerned. For disclosure purposes, it is noted that the electro-optic coefficient of a waveguide material is indicative of the response plane's orientation in the cross-coupling material.

In cases where a polymer is used as the cross-coupling material, it is known that the orientation of the response plane in the polymer that is established by its electro-optic coefficient can be influenced by a process commonly referred to as “poling” (i.e. it can be changed, at least to some extent). For other materials, however, the electro-optic coefficient and the resultant orientation of its response plane may be a fixed characteristic of the material. In any event, regardless whether the waveguide is made of a polymer, a SiON/silica material or some other material well known in the pertinent art, the electro-optic coefficient is an important consideration.

With the above in mind, the interaction between the electro-optic coefficient orientation in the cross-coupling material, and the electric field of an optical signal as it passes through the cross-coupling material between waveguides (e.g. TM mode), needs to be somehow accounted for. For this purpose, in order to optimize the electro-optic modulation efficiency of a switching device (modulator), it is necessary to have the response plane of the cross-coupling material aligned as nearly parallel to the externally applied electric field, E, in the cross-coupling material as possible. To do this, the electro-optic coefficient orientation in the cross-coupling material should be aligned parallel with the flux lines of the externally applied electric field, as nearly as possible.

As examples of applications involving the above, first consider the case where a polymer is used as the cross-coupling material. In this case, the orientation of the electro-optic coefficient of the cross-coupling material relative to the flux lines of the applied electric field, E, are preferably parallel to each other (e.g. TM mode). On the other hand, in most quantum well cases, the externally applied electric field, E, is perpendicular to the electro-optic coefficient of the cross-coupling material (e.g. TE mode). Thus, in these examples, it is preferable for the externally applied electric field and the electro-optic coefficient to have different alignment orientations.

In light of the above, it is an object of the present invention to provide an electro-optically coupled switch having a cross-coupling material with a refractive index, n_{c}, that ensures good optical confinement between two waveguides. Another object of the present invention is to provide an electro-optically coupled switch with a cross-coupling material having a refractive index, n_{c}, that establishes a strong electro-optic modulation coefficient. Yet another object of the present invention is to design the structure for an electro-optic switch having the proper waveguide separation to achieve strong waveguide cross-coupling; while maximizing the electro-optic efficiency of the device by providing good optical confinement in the cross-coupling material that facilitates the transfer of light into or out of the waveguide. Yet another object of the present invention is to have the response plane of the cross-coupling material (determined by the electro-optic coefficient of the cross-coupling material) aligned as nearly parallel as possible to the flux lines of the externally applied electric field, E, to thereby optimize electro-optic modulation efficiency of the device. Still another object of the present invention is to provide a multi-step procedure for the manufacture of the electro-optically coupled switch. Another object of the present invention is to provide an electro-optically coupled switch wherein a uniform electric field, E, is confined and directed through a layer of cross-coupling material that is sandwiched between two optical waveguides, and wherein the electric field intensity is normal to the layer of cross-coupling material. Still another object of the present invention is to provide an electro-optically coupled switch that is simple to manufacture, is easy to use and is comparatively cost effective.

### SUMMARY OF THE INVENTION

In accordance with the present invention, a vertical electro-optically coupled switch includes first and second waveguides, with a layer of cross-coupling material positioned between the waveguides. In combination, the first and second waveguides, together with the cross-coupling material located therebetween, create what is sometimes hereinafter referred to as a waveguide stack. In any event, an electric field, E, is established through the cross-coupling material. Variations in E can then be made (i.e. a switching voltage, V_{π}) to change the refractive index of the cross-coupling material, n_{c} (i.e. n_{c}≡nₑₒ). The intended result here is to transfer the transmission of an optical signal, λ, from one waveguide to the other. Several structural aspects of the cross-coupling material, as well as functional aspects, of the electric field, E, are particularly important.

For purposes of the present invention, the layer of cross-coupling material should have a depth, d, and it should be coextensive with the length, L, of the waveguides. As envisioned for the present invention, the refractive index of a first waveguide, n_{wg1}, will be equal to, or nearly equal to, the refractive index of a second waveguide, n_{wg2} (i.e. n_{wg1}≈n_{wg2}). Typically, the distance, d, between waveguides will be smaller than the value of λ/n_{wg} (i.e. d<λ/n_{wg}). Further, the waveguide width, W, is optimized to improve optical confinement and to reduce optical loss.

With regard to the electric field, E, as noted above it must be strong and uniform. Further, flux lines of the electric field, E, are to be oriented substantially perpendicular to the layer of cross-coupling material that is positioned between the waveguides. Furthermore, the electric field, E, is to be confined between the waveguides across the entire layer of the cross-coupling material. To do this a filler material having a refractive index, n_{f}, is positioned against the cross-coupling material between the waveguides.

For a construction of the present invention, the depth, d, of the cross-coupling material, the length, L, of the waveguides, and the refractive indexes n_{wg1}, n_{wg2}, and n_{c}, as well as the field strength for E, all need to be selected and based upon the wavelength, λ, of the optical signal that is being transmitted. As envisioned for the present invention, the cross-coupling material may be a polymer, when the first and second waveguides are also polymers. The cross-coupling material may also be a polymer when the waveguides are a SiON/silica material. On the other hand, if the waveguides are doped materials then, depending on the doping used, the cross-coupling material can either be a polymer, a PIN planar-diode-structure semiconductor, or a PIN multiple-quantum-well semiconductor.

A voltage source is connected to the waveguide stack for selectively establishing a uniform electric field, E, through the cross-coupling material. Preferably, the electric field, E, is confined in the cross-coupling material by a filler material which encloses the cross-coupling material between the first waveguide and the second waveguide. Furthermore, and most importantly, the electric field, E, is oriented everywhere across the cross-coupling material, perpendicular to the layer of cross-coupling material.

Incorporated with the voltage source is an electric switch. Specifically, this switch is a means for imposing a switching voltage, V_{π}, to the waveguide stack. In particular, the switching voltage, V_{π}, is used to selectively change the refractive index, n_{c}, of the cross-coupling material.

In a preferred embodiment of a waveguide stack for the present invention, the first waveguide and the second waveguide are made of a SiON/silica material, and the cross-coupling material is a polymer. For this embodiment, the means for imposing V_{π} on the waveguide stack includes a first transparent electrical contact that is connected with the voltage source and is positioned between the first waveguide and the cross-coupling material. A second transparent electrical contact which is connected with the voltage source and positioned between the second waveguide and the cross-coupling material is also included. In a variation of the preferred embodiment, the first waveguide, the second waveguide and the cross-coupling material can all be made of a polymer.

In a first alternate embodiment of the present invention, the first waveguide and the second waveguide are each made of a same, lightly-doped, electrically-conductive material, and the waveguides are individually positioned in contact with the voltage source. Specifically, both the first waveguide and the second waveguide are N doped. The means for imposing the switching voltage, V_{π}, to the waveguide stack will then include a first N⁺ doped layer that is positioned in electrical contact between the first N doped waveguide and the voltage source. Similarly, a second N⁺ doped layer is positioned in electrical contact between the second N doped waveguide and the voltage source. For this embodiment of the present invention the cross-coupling material is preferably a polymer.

In a second alternate embodiment of the present invention, the first waveguide is P doped and the second waveguide is N doped. In this case, the means for imposing V_{π} to the waveguide stack includes a first P⁺ doped layer positioned in electrical contact between the first P doped waveguide and the voltage source. Also, a second N⁺ doped layer is positioned in electrical contact between the second N doped waveguide and the voltage source. For this second alternate embodiment the cross-coupling material can be either a PIN planar-diode-structure semiconductor, or a PIN multiple-quantum-well semiconductor.

For an operation of the present invention, the switch can include a first input port at the upstream end of the first waveguide, and a first output port at the downstream end of the first waveguide. Also, the switch can include a second output port at the downstream end of the second waveguide. With this arrangement, when an incoming optical signal, λ, is received at the first input port it can be selectively routed to the second output port by the switching voltage, V_{π}. As an additional feature of the present invention, a second input port can be used at the upstream end of the second waveguide. In this case, when an incoming optical signal, λ′, is received at the second input port, it can be selectively routed to the first output port by the switching voltage, V_{π}.

A method for manufacturing an electro-optically coupled switch in accordance with the present invention requires the creation of a base member. In detail, the base member will preferably be a rectangular shaped block having a length L, a width Wₛ, and a thickness T. Also, the base member defines a central plane that is located equidistant between opposed edges and along the length L of the base member. For its construction, the base member includes a semiconductor substrate and a layer of a lightly doped semiconductor material, with a layer of an insulator material positioned between the semiconductor substrate and the semiconductor layer.

For the manufacture of the switch in accordance with the present invention, a first mask is initially used to perform a first etch on the semiconductor layer. Structurally, the first mask is formed with a central cutout and a pair of rectangular shaped side cutouts which are positioned on opposite sides of the central cutout from each other. Together, the central cutout and the side cutouts establish a pair of parallel strips. Dimensionally, each strip will have the length L and a same width x_{w}, with a distance x_{c} between them.

In use, the first mask is aligned to cover the semiconductor layer of the base member, with the parallel strips symmetrically positioned to straddle the central plane. With the first mask in place, the first etch is performed to remove material from the layer of semiconductor material in three different areas. In detail, one area extends along the length L and through a distance x_{c} symmetrically centered on the central plane. The other two areas straddle the first area at the distance x_{w} from the first area. In these two areas, etching is done along the length L and through a distance xₑ that extends from each edge of the base member toward the central plane. In all three areas, etching is done to a same depth d₁.

Next, a second mask is used to further etch the base member. In detail, the second mask is formed with a single rectangular shaped cutout having a length L and a width W_{c} (where x_{c}+2x_{w}>W_{c}>x_{c}). In use, the second mask is aligned to cover the base member with the rectangular shaped cutout symmetrically positioned relative to the central plane. A second etch is then performed to remove material from the layer of semiconductor material on the base member to a depth d₂ along the length L and through the distance x_{c}. This etch effectively creates a slot which exposes the insulator material in the slot between opposed waveguides created by the first and second etches. As intended for the present invention, each waveguide will have a width of at least x_{w} and a length L. With regard to the first and second etches, dimensional considerations show d₂>d₁, and Wₛ=2xₑ+2X_{w}+xₓ.

A third mask is then used for a heavy semiconductor doping between each waveguide and its final metal contact to reduce switch series resistance. Specifically, the third mask is essentially a panel having a length L and a width equal to Wₛ−2x_{d}. In use, the third mask is symmetrically aligned on the base member to expose edge segments of the base member, wherein each edge segment has a width x_{d} (where x_{d}<xₑ) and is at a respectively same distance from the slot. The third mask is then used to define the area for depositing heavy semiconductor dopants into the layer of semiconductor material. This depositing is done throughout the exposed layer of semiconductor material behind the mask and above the insulator material of the base member in the edge segments.

Once the first and second etches, and the doping process have been performed, a heavily doped semiconductor material has been prepared on top of the insulator material in the edge segments to create respective contact pads. In this case, the heavily doped semiconductor material that is used for the contact pads is preferably N⁺ doped and the layer of semiconductor waveguide is preferably lightly N doped. Electrodes are then connected with each contact pad. Further, the slot between the waveguides is filled with a polymer material, and, if needed, the polymer material in the slot is poled to establish an operational electro-optic coefficient for the cross-coupling material in the slot.

As envisioned for the present invention, the first mask, the second mask, and the third mask are each made using a photo-lithography process. Further, the first etch, the second etch, and the heavy dopant deposition are each accomplished using a chemical/physical process well known in the pertinent art.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective-schematic view of a system for transmitting optical signals, which includes an electro-optically coupled switch in accordance with the present invention;

FIG. 2 is a cross-section view of an embodiment of the electro-optically coupled switch for the present invention as seen along the line 2-2 in FIG. 1;

FIG. 3 is a cross-section view of an exemplary switch in accordance with the present invention, as seen along the line 3-3 in FIG. 1, showing the switch/modulation functionality of the present invention;

FIG. 4 is a cross-section view of another embodiment of the electro-optically coupled switch for the present invention as seen along the line 4-4 in FIG. 1;

FIG. 5 is a cross-section view of still another embodiment of the electro-optically coupled switch for the present invention as seen along the line 5-5 in FIG. 1;

FIG. 6 is a perspective view of a work piece used for a manufacture of the electro-optically coupled switch of the present invention;

FIG. 7A is a cross-section of the work piece as seen along the line 7-7 in FIG. 6, with the work piece in an intermediate configuration during a manufacturing process;

FIG. 7B is a view of the work piece as seen in FIG. 7A after manufacture and ready for subsequent assembly in an operational switch;

FIG. 8 is a sequence of evolving cross-sections of the work piece as seen in FIGS. 7A and 7B, with the sequence showing eight different manufacturing steps, respectively numbered (1) through (8), in a manufacture of the present invention;

FIG. 9A is a top plan view of a first mask for use in the manufacture of the present invention;

FIG. 9B is a top plan view of a second mask for use in the manufacture of the present invention; and

FIG. 9C is a top plan view of a third mask for use in the manufacture of the present invention.

### DESCRIPTION OF THE PREFERRED EMBODIMENTS

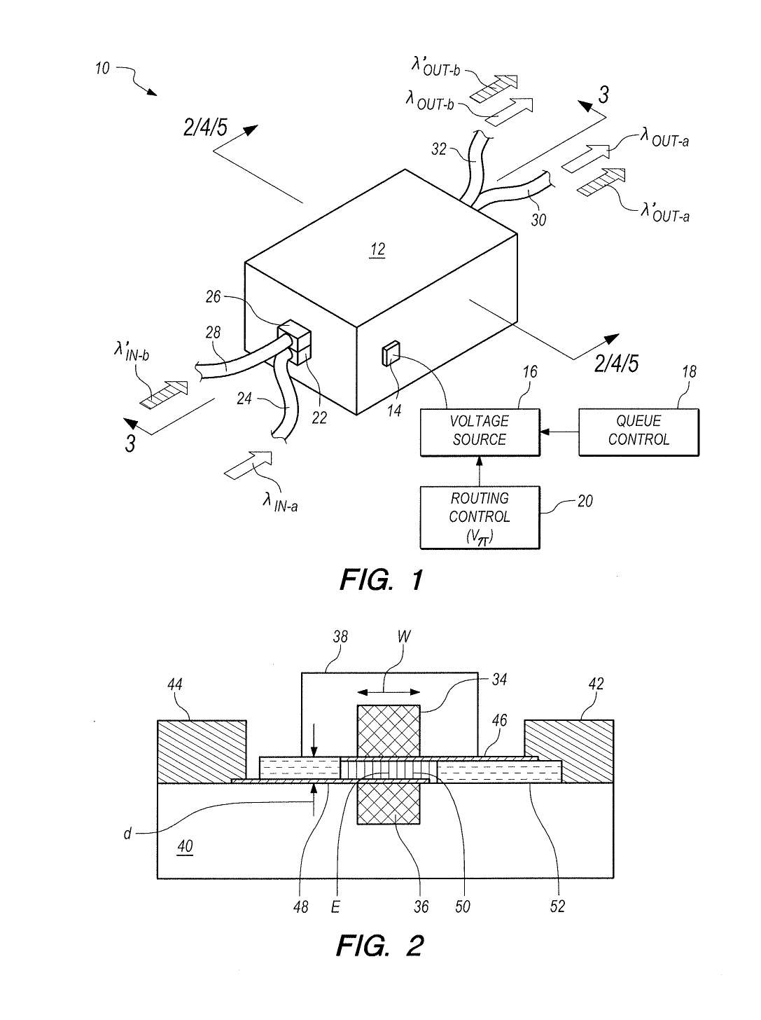

Referring initially to FIG. 1, an electro-optically coupled switch in accordance with the present invention is shown and is generally designated 10. As shown, the switch 10 includes an enclosure 12 for holding and protecting the electro-optic components of the switch 10. Also, an access connector 14 is provided for connecting the electro-optic components (not shown in FIG. 1) with an external voltage source 16. A queue control 18 and a routing control 20 are incorporated with the voltage source 16 to respectively provide for the sequencing, routing and modulation of optical signals, λ, as they pass through the electro-optically coupled switch 10.

Still referring to FIG. 1, it will be seen that the enclosure 12 includes an input port 22 for optically connecting an optical waveguide 24 with the switch 10. Similarly, an input port 26 is provided by the enclosure 12 for optically connecting an optical waveguide 28 with the switch 10. It is to be appreciated that the optical waveguides 30 and 32 will have similar connections with the enclosure 12.

In FIG. 2 the internal, electro-optic components for a preferred embodiment of the switch 10 are shown. There it will be seen that the switch 10 includes a waveguide 34 and a waveguide 36 that are respectively protected by a cladding 38 and a cladding 40. In more detail, each waveguide 34 and 36 has a width, W, and a length, L, and they are vertically aligned in parallel with each other. Further, as shown, the switch 10 includes a metal connector 42 (e.g. +V) and a metal connector 44 (e.g. −V) which are respectively connected with a transparent electrical contact 46 and a transparent electrical contact 48. Further, a cross-coupling material 50 is positioned between the transparent electrical contacts 46 and 48. In accordance with the present invention, the transparent electrical contacts 46 and 48 are in direct contact with the cross-coupling material 50, and are everywhere separated from each other by a distance, d. Further, the transparent electrical contacts 46 and 48 are positioned opposite each other from the cross-coupling material 50. And, they are each positioned between the cross-coupling material 50 and a respective waveguide 34 and 36. Additionally, a filler material 52 is provided to electrically confine the cross-coupling material 50 between the transparent electrical contacts 46 and 48.

Within the combination of components for the switch 10 shown in FIG. 2, the differences in the refractive index of the various materials used are important. In detail, the refractive index of waveguide 34 (a first waveguide), n_{wg1}, will be equal to, or nearly equal to, the refractive index of waveguide 36 (a second waveguide), n_{wg2}. For purposes of the present invention, the refractive indexes of the waveguides 34 and 36 will be the same, or nearly the same, n_{wg1}≈n_{wg2}. Importantly, however, the refractive index of the cross-coupling material 50, n_{c}, (also sometimes noted herein as nₑₒ) needs to be much greater than the respective indexes n_{wg1} and n_{wg2} of the first and second waveguides 34 and 36 (i.e. n_{wg1}<<n_{c}>>n_{wg2}). As noted above, this arrangement is made to achieve strong waveguide cross-coupling, good optical confinement in the cross-coupling material, and efficient electro-optic modulation, with a proper waveguide separation distance, d. For example, n_{c}=1.7, n_{wg}=1.57, and d=0.5 μm. Also, the refractive index of the filler material 52, n_{f}, needs to be smaller than all of the others (i.e. n_{c}>>n_{wg(1 and 2)}>n_{f}, and n_{wg1}≈n_{wg2}).

As shown, the metal connector 42 and the metal connector 44 are separately connected with the voltage source 16. Thus, a +V can be provided to the metal connector 42 by the voltage source 16, and a −V can be provided to the metal connector 44. The result is that a switching voltage, ΔV_{π}, can be applied through the cross-coupling material 50 that will change its refractive index, n_{c}. As envisioned for the present invention, the cross-coupling material 50 may be a polymer, when the waveguides 34 and 36 are also polymers, or when the waveguides 34 and 36 are made of a SiON/silica material.

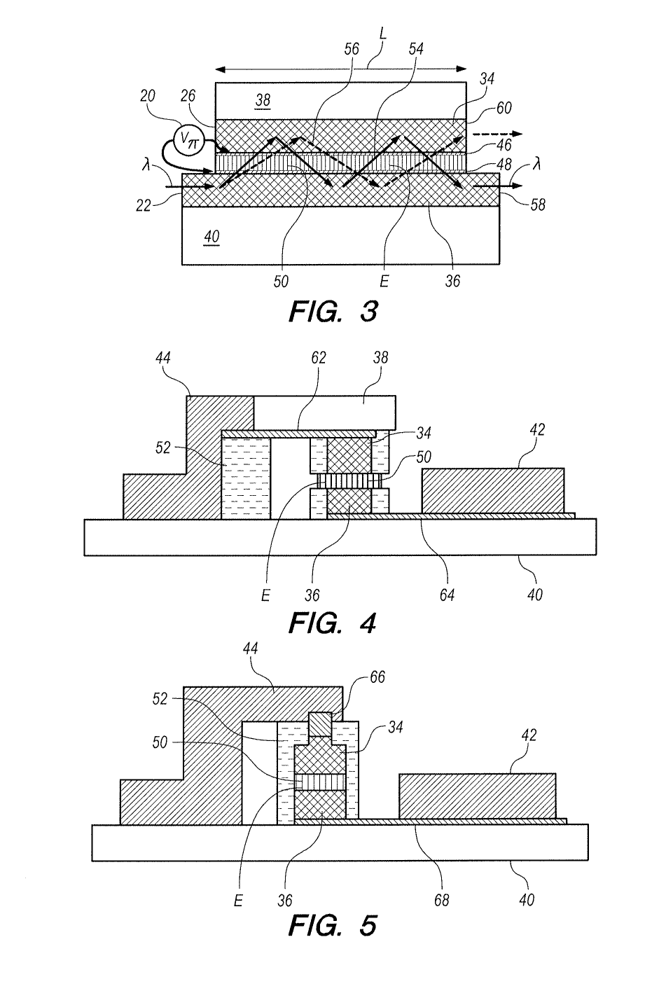

An operation of the switch 10 will be best appreciated with reference to FIG. 3. There it will be seen that, depending on the influence of the switching voltage, V_{π}, an optical signal, λ, can be directed either onto a pathway 54 (solid arrows) or a pathway 56 (dashed arrows). The consequence of this is that, the switching voltage, V_{π}, can be used to guide an optical signal, λ, which enters the switch 10 through the input port 22 to exit the switch 10 from either the output port 58 of waveguide 36 or the output port 60 of waveguide 34.

With the above in mind, and by returning to FIG. 1, it will be appreciated that the routing control 20 can influence the voltage source 16 to selectively establish the switching voltage, V_{π}, and thereby generate the electrical field, E. Importantly, the electrical field, E, when generated, is uniform with the flux lines of the field oriented substantially perpendicular to the length, L, of the waveguides 34 and 36. As mentioned above, the purpose here is to influence the transit of an optical signal, λ, through the switch 10.

For an exemplary operation of the switch 10, refer back to FIG. 1. In this example, consider an optical signal, λᵢₙ₋ₐ, as input from optical waveguide 24, into the waveguide 36 via input port 22. Also consider an optical signal, λ′_{in-b}, as input from optical waveguide 28, into the waveguide 34 via input port 26. For purposes of this example, subscript “a” pertains to waveguide 36, while subscript “b” pertains to waveguide 34.

With cross-reference between FIG. 1 and FIG. 3, and first considering only the optical signal, λ, it is to be appreciated that with no switching voltage, V_{π}, there is no electric field, E, through the cross-coupling material 50. Accordingly, optical signal, λᵢₙ₋ₐ, in optical waveguide 24 will enter switch 10 via input port 22, transit switch 10 on pathway 54, and exit from switch 10 via the output port 58 (FIG. 3) and into the optical waveguide 30 as optical signal, λₒᵤₜ₋ₐ. On the other hand, with a switching voltage, V_{π}, imposed on the cross-coupling material 50, an electric field, E, is generated through the cross-coupling material 50 to change the refractive index, n_{c} (nₑₒ), of the cross-coupling material 50. In this case, the optical signal, λᵢₙ₋ₐ, will transit switch 10 on pathway 56, and exit from switch 10 via the output port 60 (FIG. 3), and into the optical waveguide 32 as optical signal, λ_{out-b}.

Similarly, when considering the optical signal, A′, it is to be appreciated that with no switching voltage, V_{π}, optical signal, λ′_{in-b}, will enter switch 10 from optical waveguide 28 via input port 26. Optical signal, λ′_{in-b}, will then transit switch 10 and exit via the output port 60 (FIG. 3) and into the optical waveguide 32 as optical signal, λ′_{out-b}. With a switching voltage, V_{π}, imposed on the cross-coupling material 50, however, the optical signal, λ′_{in-b}, will transit switch 10 to exit from switch 10 via the output port 58 (FIG. 3), and into the optical waveguide 30 as optical signal λ′ₒᵤₜ₋ₐ.

Still referring to FIG. 1 it is to be appreciated that the switch 10 can be used either as a switch or as a modulator. Further, it will be appreciated that the queue control 18 can be used as a gate to provide for alternating or sequential access of the optical signals, λ and λ′, to the switch 10. As will be appreciated by the skilled artisan, when switch 10 is used as a modulator, only one continuous wave (CW) light input port 22 and one optical output port (e.g. output port 58, FIG. 3) are required.

FIG. 4 shows an alternate embodiment for the present invention wherein the waveguide 34 and the waveguide 36 are each made of a same, lightly-doped, electrically-conductive material. As shown, the waveguides 34 and 36 are individually positioned in contact with the voltage source 16. For one alternate embodiment of the present invention, both the waveguide 34 and the waveguide 36 are N doped. Accordingly, the means for imposing the switching voltage, V_{π}, includes an N⁺ doped layer 62 that is positioned in electrical contact between the N doped waveguide 34 and the metal connector 44. Similarly, an N⁺ doped layer 64 is positioned in electrical contact between the N doped waveguide 36 and the metal connector 42. Preferably, for this alternate embodiment of the present invention, the cross-coupling material 50 is a polymer.

FIG. 5 shows another alternate embodiment of the present invention wherein the waveguide 34 is P doped and the waveguide 36 is N doped. In this case, the means for imposing V_{π} includes a P⁺ doped layer 66 positioned in electrical contact between the P doped waveguide 34 and the metal connector 44. Also included is an N⁺ doped layer 68 which is positioned in electrical contact between the N doped waveguide 36 and the metal connector 42. In this case, the cross-coupling material 50 can be either a PIN planar-diode-structure semiconductor, or a PIN multiple-quantum-well semiconductor.

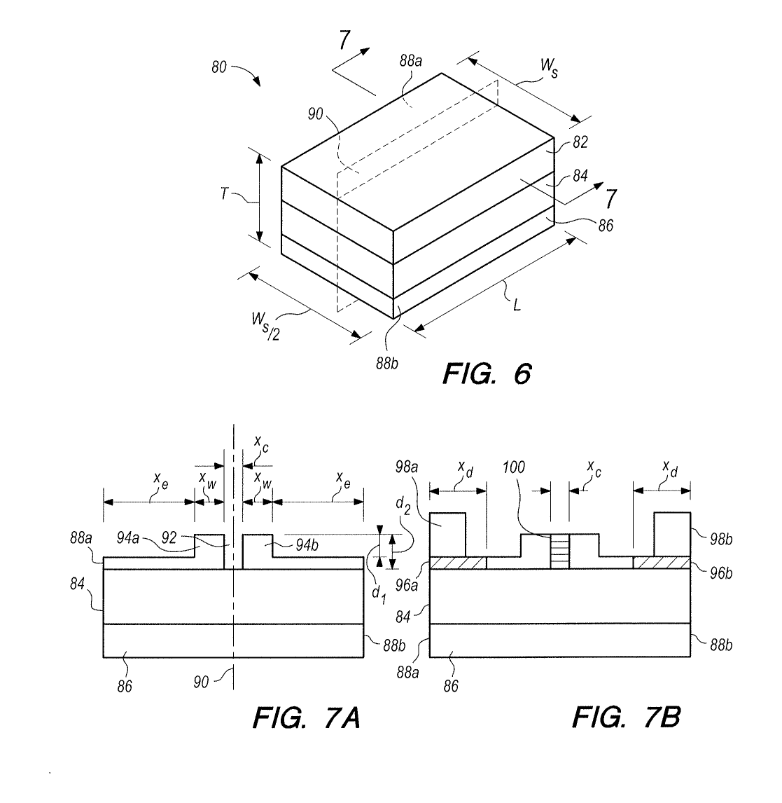

Referring now to FIG. 6, a method for manufacturing an electro-optically coupled switch in accordance with the present invention is disclosed. In FIG. 6 it will be appreciated that the method first requires providing a base member that has been generally designated 80. As shown, the base member 80 includes a layer 82 of a semiconductor material. Also, the base member 80 includes a layer 84 of an insulator material that is positioned between the semiconductor layer 82 and a substrate 86 that is also made of a semiconductor material. For purposes of the present invention, the semiconductor material that is used for the layer 82 may be of any type well known in the pertinent art, such as silicon, or compound semiconductors such as InP, GaAs, GaN, or a quantum well composition of various compound semiconductors.

When constructed, the base member 80 will have a length L, a width Wₛ and a thickness T. The base member 80 will also have opposite edges 88a and 88b which straddle the central plane 90 that is defined by the base member 80.

As an overview of the methodology for the present invention, FIG. 7A shows that the semiconductor layer 82 is to be reconfigured to form a slot 92 which is positioned along the central plane 90 between opposed waveguides 94a and 94b. Note: the depth of the slot 92 extends through the semiconductor layer 82 to expose the layer 84 of insulator material. Still referring to FIG. 7A it will be appreciated that the slot 92 will have a width x_{c} along the length L of the slot 92, and that the waveguides 94a and 94b each have an operational width x_{w} adjacent the slot 92, as well as an extension of width xₑ that extends from the waveguides 94a and 94b toward the edges 88a and 88b of the base member 80.

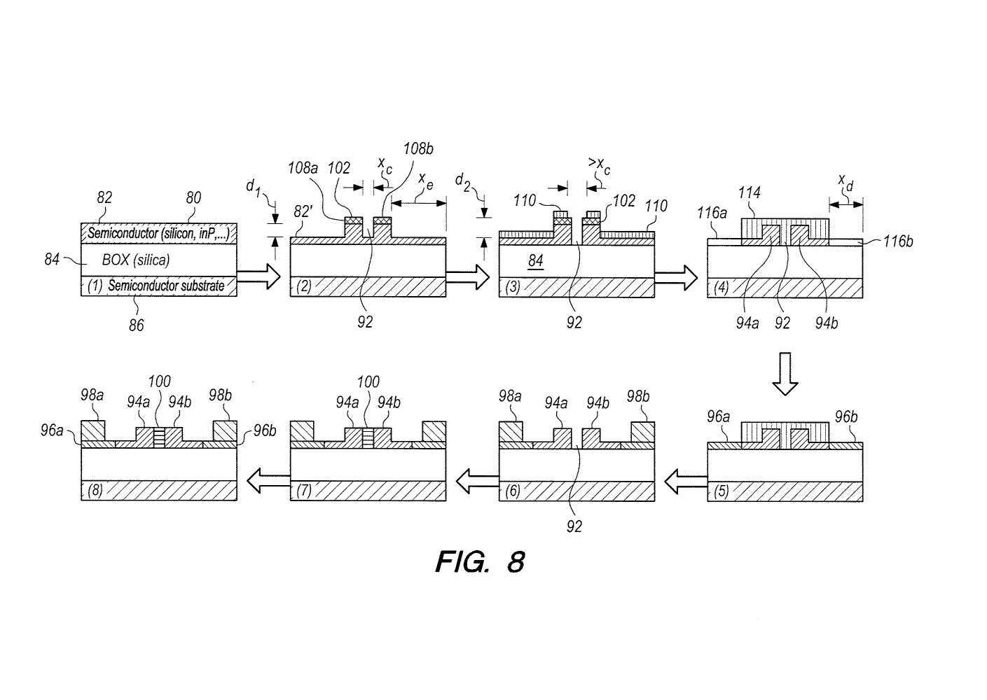

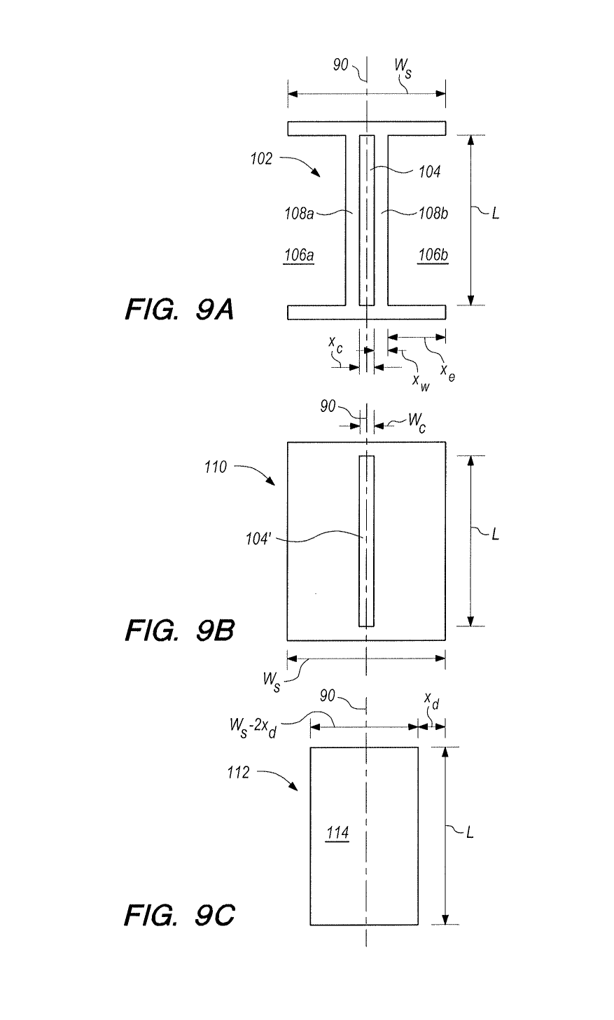

FIG. 7B shows that the semiconductor layer 82 will be further reconfigured to form contact pads 96a and 96b at the edges 88a and 88b of the base member 80. Additionally, metal electrodes 98a and 98b are then to be positioned in electrical contact with the respective contact pads 96a and 96b. Further, FIG. 7B shows that the slot 92 is filled with a cross-coupling material 100. For purposes of the present invention, the cross-coupling material 100 can be of any type material known in the pertinent art for the specified purposes of the present invention. Preferably, the cross-coupling material 100 will be a polymer. With the above overview in mind, the methodology of the present invention is best appreciated with reference to FIG. 8 and FIGS. 9A, 9B and 9C.

FIG. 8 shows that the method for manufacturing an electro-optically coupled switch is essentially an eight step process. In FIG. 8, these steps are designated sequentially as (1), (2), (3) . . . (8). To begin, as shown in FIG. 8(1), a base member 80 is constructed as disclosed above. Then, a first mask 102 is positioned on the layer 82 of semiconductor material and it is aligned on the layer 82 relative to the central plane 90 substantially as shown in FIG. 9A. As best seen in FIG. 9A, the first mask 102 is formed with a central cutout 104 and a pair of side cutouts 106a and 106b. Between the central cutout 104 and the side cutouts 106a and 106b are two parallel strips 108a and 108b that are separated from each other by the distance x_{c}. With the first mask 102 in position on the layer 82, FIG. 8(2) shows that, in a first etch, the semiconductor material in the layer 82 is etched to a depth of d₁. The result here is to create a reconfigured layer 82′ that is formed with the slot 92.

FIG. 8(3) shows that after the first etch, a second mask 110 is positioned over the first mask 102. FIG. 9B shows that this second mask 110 is formed with only a central cutout 104′. For purposes of the present invention, this central cutout 104′ can be formed with a width W_{c} where x_{c}<W_{c}<x_{c}+2x_{w}. In any event, the second mask 110 is intended to mask the entire layer 82′ with the exception of the slot 92. Accordingly, in a second etch, with the second mask 110 in place, the layer 82′ of semiconductor material can be further reconfigured. Specifically, as shown in FIG. 8(3), semiconductor material in the slot 92 can be removed through the depth d₂ to expose insulator material in the layer 84. The second mask 110 and the first mask 102 can then be removed.

In the next sequential step, FIG. 8(4) shows that a third mask 112 is positioned over the layer 82 of semiconductor material to cover the slot 92 and portions of the waveguides 94a and 94b. For the present invention, the third mask 112 is essentially a solid panel 114 (See FIG. 9C). This effectively exposes the edge segments 116a and 116b shown in FIG. 8(4). Thus, semiconductor material in the edge segments 116a and 116b of layer 82 can be heavily doped in this process. As shown in FIG. 8(5), after the doping of edge segments 116a and 116b, the respective contact pads 96a and 96b can be formed. As noted above, the contact pads 96a and 96b are preferably formed by N⁺ doped semiconductor material.

With the above in mind, it follows as shown in FIG. 8(6) that metal electrodes 98a and 98b can be positioned on respective contact pads 96a and 96b. FIG. 8(7) then indicates that the next step in the methodology is to fill the slot 92 with a cross-coupling material 100, such as an electro-optical polymer. A final step, which is appreciated with reference to FIG. 8(8), is that the cross-coupling material 100 (i.e. electro-optical polymer) can be poled in the slot 92 to optimize its electro-magnetic coefficient for cross-coupling optical signals as they pass through the waveguides 94a and 94b.

While the particular Method for Configuring an Optical Modulator as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1. An electro-optically coupled switch which comprises:
a base member having a length L, a width Wₛ, and a thickness T, wherein the base member defines a central plane located equidistant between opposed edges of the base member, and wherein the base member includes a layer of a semiconductor material and a layer of silicon, with a layer of a silica insulator positioned therebetween, wherein the semiconductor material has been modified by removing material therefrom to a depth d₁ along the length L through a distance xₑ extending from each edge of the base member toward the central plane, and further wherein the semiconductor material has been modified by removing material therefrom to a depth d₂ along the length L through a distance x_{c} symmetrically centered on the central plane, to create a slot through the semiconductor material between opposed waveguides formed in the semiconductor material, wherein each waveguide has a width x_{w} and a length L, and wherein d₂>d₁, and Wₛ=2xₑ+2x_{w}+x_{c};
a polymer cross-coupling material filling the slot;
a pair of contact pads, wherein each contact pad extends through a distance x_{d} from each edge of the base member for connection with a respective waveguide, wherein x_{d} is less than xₑ (x_{d}<xₑ); and
a respective metal electrode connected with a respective contact pad to selectively provide a switching voltage V_{π} from a voltage source for the electro-optically coupled switch.

2. The switch recited in claim 1 further comprising a voltage source connected with the metal electrodes and with a respective contact pad to selectively provide a switching voltage V_{π} for the electro-optically coupled switch.

3. The switch recited in claim 1 wherein the contact pads are heavily doped (N⁺) and the waveguides are lightly doped (N⁻).

4. A method for manufacturing an electro-optically coupled switch comprising the steps of:
creating a base member having a length L, a width Wₛ, and a thickness T, wherein the base member defines a central plane located equidistant between opposed edges of the base member, and wherein the base member includes a layer of a semiconductor substrate and a layer of a semiconductor material, with a layer of an insulator material positioned therebetween;
performing a first etch by removing material from the layer of semiconductor material on the base member to a depth d₁, along the length L through a distance xₑ extending from each edge of the base member toward the central plane and along the length L through a distance x_{c} symmetrically centered on the central plane;
performing a second etch by removing material from the layer of semiconductor material on the base member to a depth d₂ along the length L and through the distance x_{c} to create a slot exposing the insulator material in the slot between opposed waveguides, wherein each waveguide has a width of at least x_{w} and a length L, and wherein d₂>d₁, and Wₛ=2xₑ+2x_{w}+x_{c};
filling the slot with a polymer to function as a cross-coupling material;
doping the semiconductor material through a distance x_{d} from each edge of the base member to establish respective contact pads along each edge of the base member, for connection of each contact pad with a respective waveguide, wherein x_{d} is less than xₑ (x_{d}<xₑ); and
interconnecting a metal electrode with a respective contact pad to selectively provide a switching voltage V_{π} from a voltage source for the electro-optically coupled switch.

5. The method recited in claim 4 further comprising the step of poling the polymer in the slot to optimize an electro-optic coefficient for the cross-coupling material to accommodate an optical signal passing through the electro-optically coupled switch.

6. The method recited in claim 5 wherein the poling step optimizes an orientation of the electro-optic coefficient with a TE mode of the optical signal.

7. The method recited in claim 4 further comprising the step of passivating the layer of semiconductor material.

8. The method recited in claim 4 wherein the semiconductor material is selected from the group consisting of silicon, compound semiconductor InP, GaAs, GaN, and quantum well semiconductors.

9. The method recited in claim 4 wherein the doping step further comprises the steps of:
performing a third doping process into the layer of semiconductor material through the distance x_{d} to the depth d₂ along the length L at each edge of the base member in its respective edge segment to create respective contact pads for connection with a metal electrode; and
N⁺ doping the contact pads to reduce switch series resistance.

10. The method recited in claim 9 further comprising the steps of:
providing a first mask for the first etch, wherein the first mask is formed with a central cutout and a pair of rectangular shaped side cutouts positioned on opposite sides of the central cutout from each other to define a pair of parallel strips, with each strip having the length L and a width x_{w} with the distance x_{c} therebetween;
aligning the first mask to cover the base member with the parallel strips symmetrically positioned to straddle the central plane;
providing a second mask for the second etch, wherein the second mask is formed with a single rectangular shaped cut-out having a length L and a width equal to W_{c} wherein x_{c}<W_{c}<x_{c}+2x_{w};
aligning the second mask to cover the base member with the rectangular shaped cut-out symmetrically positioned relative to the central plane;
providing a third mask for the heavily doped region to reduce switch series resistance wherein the third mask is a panel having a length L and a width equal to Wₛ−2x_{d}; and
aligning the third mask symmetrically on the base member to dope the edge segments of the base member.

11. The method recited in claim 9 wherein the first mask, the second mask, and the third mask are made using a photo-lithography process.

12. The method recited in claim 9 wherein the first etch and the second etch are accomplished using a chemical/physical process.

13. A method for manufacturing an electro-optically coupled switch comprising the steps of:
providing a base member having a semiconductor substrate and a layer of a semiconductor material, with a layer of insulator material positioned therebetween;
positioning a first mask against the layer of semiconductor material;
etching the layer of semiconductor material behind the first mask to remove the layer of semiconductor material to a depth d₁, and to form a slot straddled by opposed waveguides;
positioning a second mask against the opposed waveguides;
etching the layer of semiconductor material in the slot to a depth d₂ to expose insulator material in the slot between the opposed waveguides, wherein d₂ is greater than d₁ (d₂>d₁);
positioning a third mask over the slot and over the opposed waveguides to expose an edge segment for each waveguide, wherein each edge segment is at a respectively same distance from the slot;
doping the exposed segments of each waveguide in the layer of semiconductor material to the depth d₂ and to the edge segments beyond the waveguide from the slot to create respective contact pads;
connecting an electrode with each contact pad;
filing the slot with a polymer material; and
poling the polymer material in the slot.

14. The method recited in claim 13 wherein the layer of semiconductor material is selected from the group consisting of silicon, compound semiconductor such as InP, GaAs, GaN, and quantum well compound semiconductor materials.

15. The method recited in claim 13 wherein the layer of semiconductor material is a lightly doped N⁻ material and the contact pads are heavily N⁺ doped material to reduce the switch series resistance.

16. The method recited in claim 13 wherein the insulator material is silica.

17. The method recited in claim 13 wherein the polymer material used in the poling step is an electro-optic cross-coupling polymer, and the poling step is accomplished to optimize an alignment of the electro-optic coefficient of the polymer material.

18. The method recited in claim 13 wherein the base member is rectangular shaped having a length L, a width Wₛ, and wherein the base member defines a central plane located equidistant between opposed edges of the base member, the method further comprising the steps of:
forming a first mask wherein the first mask is formed with a central cutout and a pair of rectangular shaped side cutouts, wherein the side cutouts are on opposite sides of the central cutout from each other to define a pair of parallel strips, with each strip having the length L and a width x_{w} with the distance x_{c} therebetween;
aligning the first mask to cover the base member with the parallel strips symmetrically positioned to straddle the central plane; and
aligning the first mask to cover the base member with the parallel strips symmetrically positioned relative to the central plane.

19. The method recited in claim 18 further comprising the steps of:
forming a second mask for the second etch, wherein the second mask is formed with a single rectangular shaped central cutout having a length L and a width equal to W_{c}, wherein x_{c}<W_{c}<x_{c}+2x_{w}; and
aligning the second mask to cover the base member with the rectangular shaped cut-out symmetrically positioned relative to the central plane.

20. The method recited in claim 19 further comprising the steps of:
forming a third mask for heavy doping into the contact pads wherein the third mask is a panel having a length L and a width equal to Wₛ−2x_{d}; and
aligning the third mask symmetrically on the base member to expose edge segments of the base member.
